(19) United States
(12) Patent Application Publication
(10) Pub. No.: US 2025/0100948 A1
(43) Pub. Date: Mar. 27, 2025

(54) ALLOY COMPOSITION FOR THERMAL FUSE OF SPRINKLER

(71) Applicant: HANAAMT CO., LTD, Cheongju-si (KR)

(72) Inventor: Hong-Moule KIM, Cheongju-si (KR)

(73) Assignee: HANAAMT CO., LTD, Cheongju-si (KR)

(21) Appl. No.: 18/472,446

(22) Filed: Sep. 22, 2023

(51) Int. Cl. C06C 5/06; A62C 37/12; C22C 30/00

(52) U.S. Cl. CPC C06C 5/06; A62C 37/12; C22C 30/00

(57) ABSTRACT

Proposed is an alloy composition for a thermal fuse that melts when heat is detected in a sprinkler. When the fuse melts, the head of the sprinkler starts operating. The alloy composition is a low-melting point alloy composition based on bismuth, indium, tin, and silver.

### BACKGROUND

### 1. Field of the Invention

The present disclosure relates to an alloy composition for a thermal fuse of a sprinkler. When the room temperature rises above a certain temperature due to the occurrence of a fire, the thermal fuse in the sprinkler is melted from solid to liquid, and the fire extinguishing liquid is sprayed into the room using this as an operating signal.

The thermal fuse of a sprinkler requires low melting point characteristics. In the related art, harmful materials such as lead and cadmium have been mainly used due to characteristics of materials having a low melting point, but the present disclosure relates to a thermal fuse for a sprinkler suitable for safety regulations and environmental regulations through a novel alloy composition replacing lead and cadmium.

### 2. Description of the Related Art

The present disclosure relates to a sprinkler. In general, a sprinkler is a piece of fire-fighting equipment that is installed on a ceiling inside a building and extinguishes a fire by spraying extinguishing liquid, for example, water, when a fire is detected.

Although various operating structures of the sprinkler have been disclosed, the head (H) of a conventional sprinkler is, as shown in FIG. 1, configured to include: a fire extinguishing liquid outlet 1 connected to a fire extinguishing liquid supply pipe by a pipe connection socket; an O-ring type body 2 extending downward from the outer circumferential surface of the fire extinguishing liquid outlet 1; a fire extinguishing liquid diffusion plate 6 horizontally coupled to the lower outer circumferential surface of the O-ring type body 2; a discharge valve 3 blocking the fire extinguishing liquid outlet 1; a trigger 4 supporting the discharge valve 3 between the discharge valve 3 and the lower part of the body 2; and a thermal fuse F installed within the trigger 4.

A thermal fuse melts when heat is sensed. Legally, the thermal fuse must be melted at a certain temperature (e.g., 70° C. to 74° C.), and a metal alloy with a relatively low melting point must be used to satisfy the above melting temperature conditions. As such a low-melting metal, a thermal fuse containing harmful elements such as lead and cadmium has been mainly used in the related art (for example, Korean Patent Application Laid-open Publication Nos. 10-2016-0068223, 10-2012-0084850, etc.). Since heavy metals such as lead and cadmium are materials that cause environmental pollution, the development of a low melting point thermal fuse that does not use such harmful materials have been required.

As an example of an alloy composition for a thermal fuse replacing lead and cadmium, Korean Patent Laid-Open Publication No. 10-2022-0022434 discloses a fuse metal containing five or more components of indium, bismuth, copper, silver, and antimony. The fuse metal may operate at a reference temperature without a difference in Vickers hardness from conventional fuse metals. However, although lead and cadmium are not used in the above patent, antimony, which is one of the components, is a material having characteristics similar to arsenic and is known as a carcinogen and thus the alloy composition of the above patent also has a problem.

The present disclosure relates to a technology that has been researched and completed by the need for a novel alloy composition for a thermal fuse without harmful substances such as lead, cadmium, antimony, and the like.

### DESCRIPTION OF THE RELATED ART

### Patent Literatures

(Patent Literature 1) Korean Patent Application Laid-open Publication No. 10-2016-0068223
(Patent Literature 2) Korean Patent Application Laid-open Publication No. 10-2012-0084850
(Patent Literature 3) Korean Patent Application Laid-open Publication No. 10-2022-0022434

### SUMMARY

An objective of the present disclosure is to provide an alloy composition for a thermal fuse of a sprinkler having a low melting point that is melted at around 72° C. but is free of harmful substances such as lead and cadmium.

Another objective of the present disclosure is to provide an alloy composition for a thermal fuse having hardness and compressive strength suitable for a thermal fuse of a sprinkler.

In addition, the other objective of the present disclosure is to provide an alloy composition for a thermal fuse of a sprinkler having a low melting point through a eutectic point composition.

The present disclosure provides a composition for thermal fuse of sprinkler containing bismuth, indium, tin, and silver.

In particular, the content range of each component in the present disclosure may be 35% to 45% by weight of bismuth, 35% to 45% by weight of indium, 10% to 25% by weight of tin, and 0.001% to 5% by weight of silver.

In particular, the content range of each component in the present disclosure may be 40% to 45% by weight of bismuth, 40% to 45% by weight of indium, 15% to 20% by weight of tin, and 0.001% to 3% by weight of silver.

In particular, in the present disclosure, at least one of aluminum and vanadium may be further added in an amount of 0.001% to 2% by weight.

The thermal fuse of the sprinkler with the alloy composition containing bismuth, indium, tin, and silver of the present disclosure has a low melting point of about 72° C. and is precisely dissolved at the sprinkler operating standard temperature. In addition, the alloy composition of the present disclosure has no difference in Vickers hardness and is harmless to the human body when compared with the conventional low melting point alloy for thermal fuses containing harmful elements such as lead, cadmium, and antimony, so there is no problem in application to sprinklers.

### BRIEF DESCRIPTION OF THE DRAWINGS

FIG. 1 is a cross-sectional view showing the structure of a conventional sprinkler;

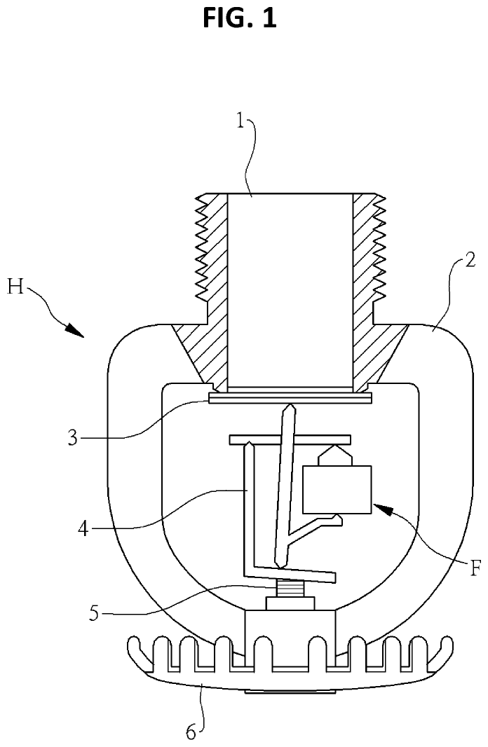

FIG. 2 is a result of a compression strength test of the sample according to an embodiment of the present disclosure; and

FIG. 3 is a result of a melting point test of the sample according to an embodiment of the present disclosure.

### DETAILED DESCRIPTIONS

The present disclosure provides an alloy composition for a thermal fuse of sprinkler containing bismuth, indium, tin, and silver.

The mixing ratio of each component may be 35% to 45% by weight of bismuth, 35% to 45% by weight of indium, 10% to 25% by weight of tin, and 0.001% to 5% by weight of silver. In particular, the mixing ratio of each component in the present disclosure may be 40% to 45% by weight of bismuth, 40% to 45% by weight of indium, 15% to 20% by weight of tin, and 0.001% to 3% by weight of silver. The content range is a eutectic point or a content range adjacent to the eutectic point and has the advantage of realizing a low melting point while using the physical properties (hardness, compressive strength, etc.) of each component. The composition of the present disclosure may satisfy temperature and strength conditions suitable for the thermal fuse of sprinkler while replacing materials such as lead and cadmium used in the related art through such low melting point characteristics.

In addition, in the present disclosure, any one or more of aluminum and vanadium may be further added in an amount of 0.001% to 2% by weight. When Al and/or V are added to the composition of the present disclosure, the hardness value and compressive strength value of the thermal fuse may be increased. When Al and/or V are added to the composition of the present disclosure, the melting point of the thermal fuse is expected to rise by about 0.8° C. to 1.2° C. The addition of Al and/or V does not affect the target melting point of 72±3° C., so it is considered a meaningful composition to improve physical properties, and the expected hardness value is expected to be 9.8 to 10.3.

Hereinafter, the present disclosure will be described in more detail through experimental examples.

### Experimental Example 1: Density Measurement

After preparing seven metal alloy samples containing 40.2% by weight of bismuth, 42.5% by weight of indium, 17.3% by weight of tin, and 0.003% by weight of silver, the density was measured. The results are shown in Table 1 below. The average density was 8.2750 g/cm³.

The higher the density value, the faster the separation rate of the thermal fuse after melting by the reaction heat, and thus the desirable density is 8 g/cm³ or more, and the sample of the present disclosure is found to be suitable for use in the thermal fuse as an average density of 8.275 g/cm³.

TABLE 1

| Example Sample No. | Density (g/cm³) |
|---|---|
| 1 | 8.5952 |
| 2 | 8.4489 |
| 3 | 8.1363 |
| 4 | 8.4651 |
| 5 | 8.4418 |
| 6 | 8.4090 |
| 7 | 8.4285 |
| Average | 8.2750 |

### Experimental Example 2: Vickers Hardness

Vickers hardness was measured for seven samples of Example of Experimental Example 1. Vickers hardness is important to be used for thermal fuse, and as a result of measuring the Vickers hardness for seven samples, the average was 9.5 (load 10 g during experiment, indentation time 15 seconds condition).

Since the thermal fuse as some components of the sprinkler is physically in contact with other components, it is preferable to maintain a predetermined hardness value or more. The sample of the embodiment of the present disclosure has an average Vickers hardness of 9.5, and this number is similar to the conventional thermal fuse, and it may be seen that there is no problem in assembly.

### Experimental Example 3: Compression Strength

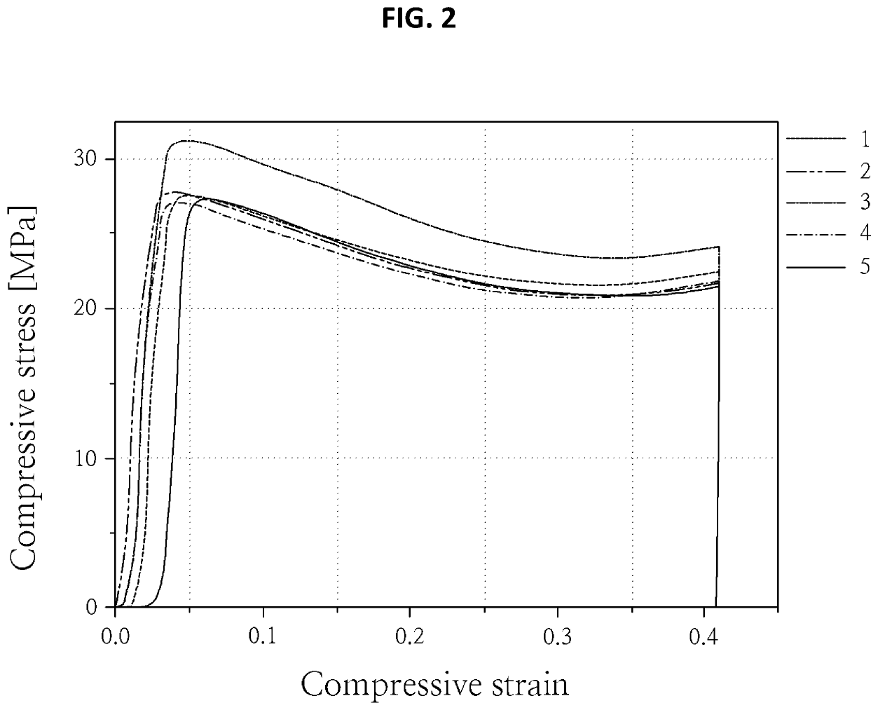

FIG. 2 is a result of a compression strength test. After preparing five samples with the same composition as in Experimental Example 1, a compression strength test was performed. The average yield strength of the five samples of this embodiment was 22.7 MPa, and the peak strength was 28.2 MPa.

Since the thermal fuse is physically in contact with other parts inside the sprinkler and is under constant pressure by water pressure, it is preferable that the compression strength value is 20 MPa or more based on the yield strength. As shown in Experimental Example 3 of the present disclosure, it may be seen that the thermal fuse prepared according to the embodiment of the present disclosure has a yield strength of 22.7 MPa, similar to that of the related art, thereby exhibiting appropriate physical strength.

### Experimental Example 4: Melting Point

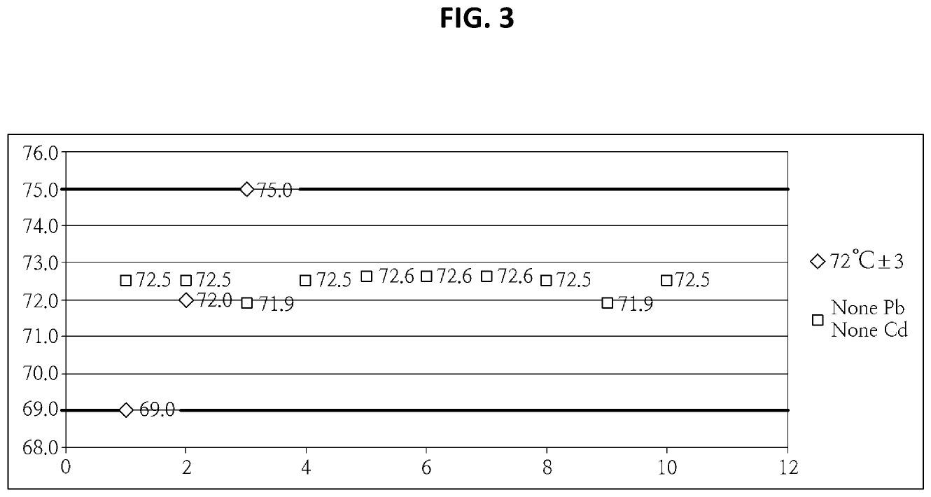

As a result of measuring the melting points of 10 thermal fuse samples prepared with the same composition as in Experimental Example 1, the results are shown in Table 2 and FIG. 3.

TABLE 2

| Sample | 1 | 2 | 3 | 4 | 5 | 6 | 7 | 8 | 9 | 10 |
|---|---|---|---|---|---|---|---|---|---|---|
| Melting point | 72.5 | 72.5 | 71.9 | 72.5 | 72.6 | 72.6 | 72.6 | 72.5 | 71.9 | 72.5 |
| temperature | | | | | | | | | | |
| (° C.) | | | | | | | | | | |

It may be seen that the alloy composition prepared according to the embodiment of the present disclosure has a melting point of 72° C. and satisfies the melting point required for a thermal fuse of a sprinkler.

What is claimed is:

1. An alloy composition for a thermal fuse of a sprinkler, the composition comprising bismuth, indium, tin, and silver.

2. The composition of claim 1, wherein the composition comprises 35% to 45% by weight of bismuth, 35% to 45% by weight of indium, 10% to 25% by weight of tin, and 0.001% to 5% by weight of silver.

3. The composition of claim 2, wherein the composition comprises 40% to 45% by weight of bismuth, 40% to 45% by weight of indium, 15% to 20% by weight of tin, and 0.001% to 3% by weight of silver.

4. The composition of claim 1, further comprising at least one of aluminum and vanadium as an additional component.

5. The composition of claim 2, further comprising at least one of aluminum and vanadium as an additional component.

6. The composition of claim 3, further comprising at least one of aluminum and vanadium as an additional component.

7. The composition of claim 4, wherein the additional component is contained in an amount of 0.001% to 2% by weight.

8. The composition of claim 5, wherein the additional component is contained in an amount of 0.001% to 2% by weight.

9. The composition of claim 6, wherein the additional component is contained in an amount of 0.001 to 2 by weight.
